(19) United States
(12) Patent Application Publication
(10) Pub. No.: US 2015/0193743 A1
(43) Pub. Date: Jul. 9, 2015

(54) SETTLEMENT FACILITATION HUB

(71) Applicant: NewComLink Inc., Austin, TX (US)

(72) Inventors: Cynthia Reh Simmons, Austin, TX (US); Terence Paul Spielman, Austin, TX (US); Neal Emerson Rigney, Cedar Park, TX (US)

(73) Assignee: NewComLink Inc., Austin, TX (US)

(21) Appl. No.: 14/148,148

(22) Filed: Jan. 6, 2014

(51) Int. Cl. G06Q 20/02

(52) U.S. Cl. CPC G06Q 20/023; G06Q 40/02

(57) ABSTRACT

Some implementations may include a settlement facilitation hub (SFH) to receive, from one or more retailers, transaction data comprising one or more retailer transactions. The SFH may store each retailer transaction. Based on a lender identifier of each retailer transaction, the SFH may create, for a clearinghouse associated with one or more lenders, settlement transaction data that includes a portion of the stored transactions. After providing the settlement transaction data to the clearinghouse, the SFH may receive transaction results indicating results of the clearinghouse initiating, based on the settlement transaction data, a transfer of funds from a lender account to one or more retailer accounts corresponding to the one or more retailers. The SFH may update the status of the portion of the stored transactions and create a settlement report for at least one of the one or more retailers based on the updated transactions.

### BACKGROUND

A retailer may desire to offer consumers access to financing from more than one provider of financing. For example, having more than one lender may enable the retailer to complete more transactions and thereby increase sales. However, each lender may have a lender specific (e.g., proprietary) interface and lender specific format for receiving and sending data. Thus, communicating with more than one lender may be time consuming and cumbersome because the retailer may have to format the data being sent to each lender based on each lender's specific formatting requirements.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations may include a settlement facilitation hub (SFH) to receive, from one or more retailers, transaction data comprising one or more retailer transactions. The SFH may store each retailer transaction. Based on a lender identifier of each retailer transaction, the SFH may create settlement transaction data that includes a portion of the stored transactions for a clearinghouse associated with one or more lenders. After providing the settlement transaction data to the clearinghouse, the SFH may receive transaction results indicating a result of the clearinghouse initiating, based on the settlement transaction data, a transfer of funds from a lender account to one or more retailer accounts corresponding to the one or more retailers. The SFH may update the status of the portion of the stored transactions and create a settlement report for at least one of the one or more retailers based on the updated transactions.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is an illustrative architecture to provide an offer of financing to a consumer according to some implementations.

FIG. 2 is an illustrative architecture of a settlement facilitation hub in which transaction data is received from one or more retailers according to some implementations.

FIG. 3 is an illustrative architecture of a settlement facilitation hub in which settlement transaction data is sent to one or more clearinghouses according to some implementations.

FIG. 4 is an illustrative architecture of a settlement facilitation hub in which a settlement report is sent to one or more retailers according to some implementations.

FIG. 5 is an illustrative architecture of a settlement facilitation hub in which settlement transaction data is sent to two or more clearinghouses according to some implementations.

FIG. 6 is an illustrative architecture of a settlement facilitation hub in which transaction data is received from two or more retailers according to some implementations.

FIG. 7 is a flow diagram of an example process that includes creating settlement transaction data based on transaction data and conversion data according to some implementations.

FIG. 8 is a flow diagram of an example process that includes identifying a first set of transactions associated with a first clearinghouse and a second set of transactions associated with a second clearinghouse according to some implementations.

FIG. 9 is a flow diagram of an example process that includes receiving first transaction data from a first retailer and second transaction data from a second retailer according to some implementations.

FIG. 10 illustrates an example configuration of a computing device and environment that can be used to implement the modules and functions described herein.

### DETAILED DESCRIPTION

The techniques and systems described herein may enable a retailer to offer financing from multiple lenders without having to communicate (e.g., send and receive data in a specific format) with each and every lender. A retailer may integrate (e.g., communicate) with a settlement facilitation hub (SFH) that facilitates the clearing and settlement of transactions with multiple lenders. By integrating with a single entity, e.g., the SFH, the retailer can clear and settle transactions associated with multiple lenders, without having to integrate (e.g., communicate) with each individual lender. If the SFH adds additional lenders, the retailer may automatically gain access to those lenders without having to do any additional integration (e.g., beyond integrating with the SFH).

Retailers are interested in enabling consumers to complete transactions to purchase goods, services, or both. The transaction may include a purchase, a lease, or a lease to purchase goods, services, or both goods and services. A retailer may arrange some form of financing or offer of financing. Some retailers may work with a lender to provide financing. However, with a single lender, if a consumer does not meet the lender's criteria, then the consumer may be denied financing and the transaction may not be completed, resulting in the retailer losing a potential sale. To avoid losing a potential sale, the retailer may desire to enable secondary lenders, who may have different criteria as compared to the primary lender, to offer financing to the consumer. Each of the secondary lenders may have respective criteria to determine whether to offer financing to a consumer. Thus, a retailer may use multiple lenders, such as primary lender(s), secondary lenders, or both to provide an offer of financing to a consumer.

Each of multiple retailers may periodically (e.g., at the end of each day) provide transaction data including transactions to the SFH. For example, each retailer location may provide transaction data that includes transactions that occurred at each retailer location. As another example, the retailer may consolidate (e.g., merge) the transactions from more than one retailer location and provide the transaction data that includes the consolidated transactions from multiple locations.

The SFH may receive the transaction data that includes transactions (e.g., purchases), retrieve each transaction from the transaction data, and store each transaction (e.g., in one or more databases). The SFH may identify a lender associated with each transaction based on the transaction data. The SFH may determine a clearinghouse associated with the lender. For example, many lenders may use a specific clearinghouse. Examples of a clearinghouse include Discover Card's Pulse, First Data's STAR, and New York Currency Exchange (NYCE). The SFH may create settlement transaction data corresponding to each transaction of the transaction data. The settlement transaction data corresponding to a particular transaction may be formatted for the clearinghouse and the lender associated with the particular transaction. The SFH may provide the settlement transaction data to the clearinghouse of the lender that is associated with the transaction. When multiple retailers are each using multiple lenders, the SFH may provide settlement transaction data to multiple clearinghouses. The settlement transaction data sent to a particular clearinghouse may include transactions associated with multiple retailers and may be intended for lenders that use the particular clearinghouse.

In response to receiving the settlement transaction data, the clearinghouse may initiate a transfer of funds from one or more lender accounts to one or more retailer accounts. The clearinghouse may provide transaction results identifying which settlement transactions were successfully processed, which settlement transactions were unsuccessfully processed (e.g., an error occurred), which type of errors occurred (if errors occurred), etc. The transaction results may include results for transactions of lenders associated with the clearinghouse and may include results of transactions from multiple retailers. In response to receiving the transaction results, the SFH may update the status of each stored transaction. For example, if the transaction results indicate that a particular transaction was successfully completed, the SFH may update the status of the stored transaction to indicate that the particular transaction was completed. The SFH may compile a report for each retailer, providing details as to which transactions were successfully performed, the amount of funds transferred in each transaction, which transactions were unsuccessful and why, etc.

For example, a consumer may accept an offer of financing (e.g., $2000 credit limit) from lender ABC and purchase an item from retailer XYZ for $1000. Retailer XYZ may provide transaction data to the SFH indicating that (1) a purchase for $1000 occurred and (2) lender ABC financed the purchase. The SFH may store the transaction, identify clearinghouse CH1 as the clearinghouse associated with lender ABC, and create settlement transaction data, based on the transaction data, indicating that (1) a purchase for $1000 occurred and (2) information associated with settling the purchase. The SFH may create the settlement transaction data in a format that the clearinghouse CH1 is capable of receiving and acting upon. The SFH may provide the settlement transaction data to the clearinghouse CH1.

In response to receiving the settlement transaction data, the clearinghouse CH1 may initiate the transfer of funds based on the information in the settlement transaction data. In this example, the clearinghouse CH1 may initiate a transfer of funds (e.g., $1000) from an account of lender ABC to an account of retailer XYZ. The clearinghouse CH1 may provide transaction results to the SFH that indicate whether the settlement transaction, e.g., transferring $1000 from an account of lender ABC to an account of retailer XYZ, was successfully completed. In response to receiving the transaction results, the SFH may update the status of the stored transaction. For example, the SFH may update the status of the stored transaction to indicate that the funds were successfully transferred. As another example, the SFH may update the status of the stored transaction to indicate that the transfer of funds was unsuccessful and identify the problem that was encountered. The SFH may identify all updated transactions and create a report for each retailer identifying the status of the updated transactions. In this example, the SFH may provide a report to retailer XYZ indicating that the transaction was successfully processed, e.g., $1000 in funds was successfully transferred from an account of lender ABC to an account of retailer XYZ.

While $1000 is used as an example, a typical settlement may take into account fees, discounts etc., such that the actual amount transferred as part of the settlement may be less than $1000. For example, the lender involved in the transaction may be paid a fee (e.g., a flat fee or a percentage of the transaction) during the settlement process, the clearinghouse involved in the transaction may be paid a fee during the settlement process (e.g., a flat fee or a percentage of the transaction), or both the lender and the clearinghouse may be paid a fee. To illustrate, if the lender is paid a 10% fee and the clearinghouse is paid a 5% fee, then for a $1000 transaction, the lender may be paid $100 and the clearinghouse may be paid $50. In this example, $850 (e.g., $1000−$100−$50) may be transferred from the lender's account to the retailer's account to settle the transaction and the settlement report may indicate that $850 was transferred. The settlement report may provide details as to the fees paid to the lender and/or to the clearinghouse. For example, the settlement report may indicate that the total value of the purchase was $1000 and detail that $100 went to the lender, $50 went to the clearinghouse, and $850 was transferred to settle the transaction. In some cases, the SFH may be paid a fee to compensate for facilitating the transaction and the settlement report may provide details as to the fees paid to the lender, the clearinghouse, and the SFH.

Thus, the SFH may enable multiple retailers to each offer consumers access to multiple lenders. Instead of formatting and providing transaction data items for each specific lender used by each retailer, each retailer merely sends the transaction data associated with the multiple lenders to the SFH for processing. Each retailer may format the transaction data according to an SFH format instead of formatting the transaction data for multiple clearinghouses or multiple lenders who each have their own specific format. The SFH identifies the transactions associated with a particular clearinghouse and formats settlement transactions according to the format used by each clearinghouse. After the SFH sends the settlement transactions to each clearinghouse used by the various lenders, the clearinghouses initiate the transfer of funds and provide transaction results indicating whether the funds associated with each transaction were successfully transferred from a lender account to a retailer account. The clearinghouses provide transactions results to the SFH, which updates the status of the stored transactions based on the transaction results. The SFH produces a report for each retailer based on the updated transactions and sends the report to each retailer. Each report may be formatted specifically for each retailer. Thus, by using the SFH, the cost and effort (e.g., formatting data, etc.) to access multiple lenders for each retailer is significantly reduced because (1) each retailer sends transaction data in an SFH-readable format to the SFH (rather than having to format the transaction data for each clearinghouse and/or lender) and (2) each retailer receives a settlement report in a format specific to the retailer, e.g., the retailer does not modify the settlement report to a retailer-readable format because the SFH provides each retailer with the settlement report in the retailer-readable format.

### Illustrative Architectures

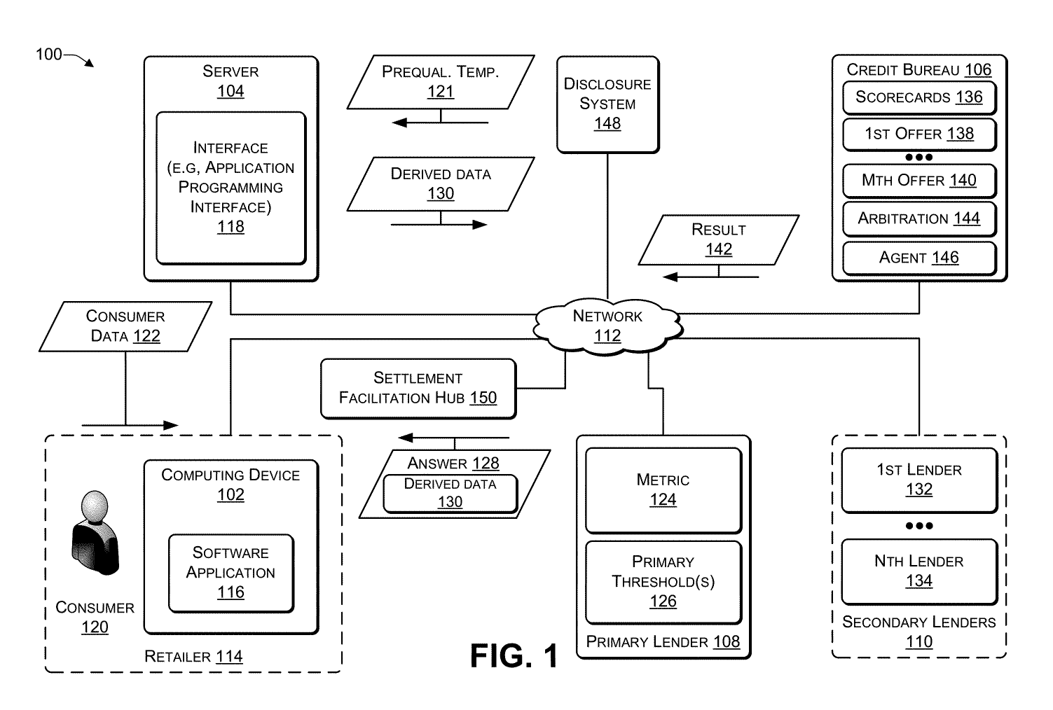

FIG. 1 is an illustrative architecture 100 to provide an offer for financing to a consumer according to some implementations. The architecture 100 includes a representative computing device 102, a server 104, a credit bureau 106, at least one primary lender 108, and one or more secondary lenders 110 communicatively coupled to a network 112. The network 112 may include one or more networks, such as a wireless local area network (e.g., WiFi®, Bluetooth™, or other type of near-field communication (NFC) network), a wireless wide area network (e.g., a code division multiple access (CDMA), a global system for mobile (GSM) network, or a long term evolution (LTE) network), a wired network (e.g., Ethernet, data over cable service interface specification (DOCSIS), Fiber Optic System (FiOS), Digital Subscriber Line (DSL) and the like), other type of network, or any combination thereof. The computing device 102 and the server 104 may each comprise a computer-based device that includes one or more processors and one or more computer-readable media to store instructions that are executable by the one or more processors to perform various functions. The computing device 102 may be a point of sale (POS) terminal or a consumer device, such as a wireless phone, a tablet computer, a personal computer, a media playback device, or other consumer device.

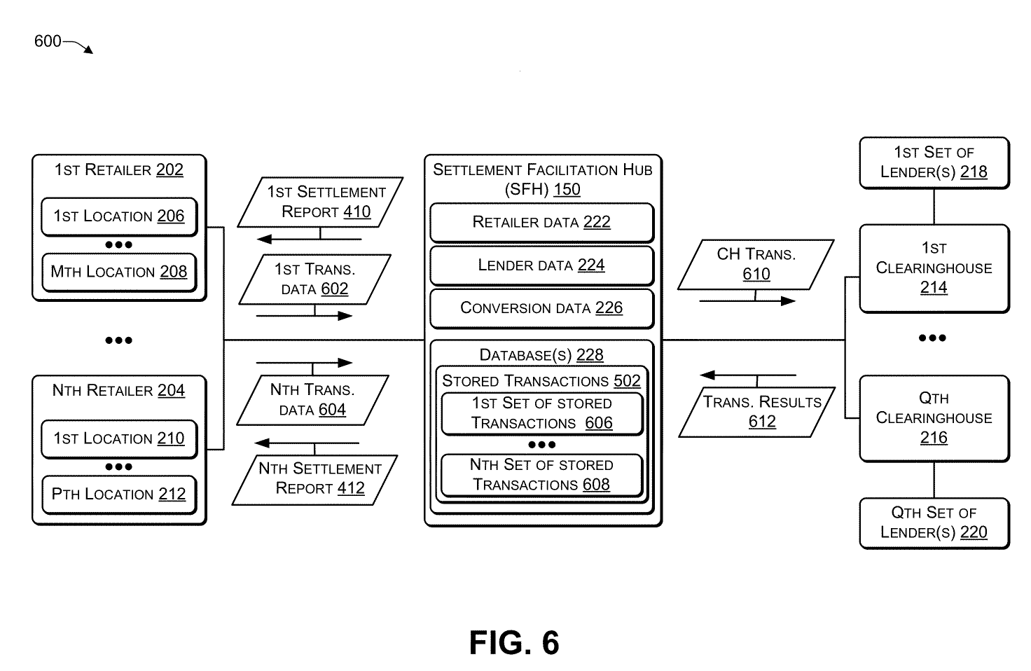

The representative computing device 102 may be located at a location of a retailer 114. While a single computing device 102 is illustrated in FIG. 1, the retailer 114 may have more than one POS terminal at each location and more than one consumer device may be located at each location of the retailer 114. The retailer 114 may have more than one location. For example, the retailer 114 may have multiple locations that are geographically dispersed and each of the multiple locations may have one or more terminal devices. The computing device 102 may be a computing device (e.g., as described in more detail in FIG. 6) with one or more processors, one or more input devices (e.g., keyboard, mouse, bar code scanner, touch-sensitive pad, etc.) and one or more computer-readable media. The computer-readable media may be used to store an operating system, device drivers, and one or more software applications, such as a representative software application 116. The software application 116 may communicate directly (e.g., using the network 112) with one or more of the credit bureau 106, the primary lender 108, or the secondary lenders 110. The software application 116 may communicate with one or more of the credit bureau 106, the primary lender 108, or the secondary lenders 110 using an interface 118 that is hosted by the server 104. For example, the interface 118 may be an application programming interface (API) or other type of software interface that can be called by the software application 116 to access one or more of the credit bureau 106, the primary lender 108, or the secondary lenders 110. The retailer 114 may be a “bricks and mortar” retailer with a physical presence or the retailer 114 may be a network-based retailer that provides a catalog of products and/or services for purchase via the interface 118 hosted by the server 104. When the computing device 102 is associated with a consumer 120, an agent (e.g., a salesclerk) of the retailer 114 may navigate a browser of the computing device 102 to the interface 118 and enter a username and password associated with the retailer 114. The interface 118 may display a prequalification form to enable the consumer 120 to enter consumer data 122 to determine whether the consumer 120 qualifies to apply for financing.

In the following examples, the computing device 102 is described as sending or receiving various data items. However, it is to be understood that in some implementations, the computing device 102 may communicate with the interface 118 to send or receive the data items. For example, the interface 118 may be a website hosted by the server 104 which is accessed by the computing device 102.

The consumer 120 may desire to initiate a transaction (e.g., to purchase, lease, or lease purchase) one or more items (e.g., goods, services, or both goods and services) from the retailer 114. Before or during the transaction, the consumer 120 may desire to finance at least a portion of the transaction. The consumer 120 may inquire whether financing is available to complete the consumer's transaction or an agent (e.g., salesclerk) of the retailer 114 may inform the consumer 102 that financing may be available. In response to the consumer 120 indicating a desire to be prequalified, the computing device 102 (or the interface 118) may provide a prequalification template request to the disclosure system 148. In response to receiving the prequalification template request, a prequalification template 121 (denoted “prequel. temp.” in FIG. 1) may be retrieved by the disclosure system and sent to the computing device 102. The prequalification template 121 may be presented to the consumer 102. In response, the consumer 120 may provide consumer data 122 (e.g., information associated with the consumer, such as the consumer's name, address, and the like) to the retailer 114. For example, the consumer data 122 may be provided to fill in the fields of the prequalification template 121.

The consumer data 122 may include data associated with the consumer 120, such as a name and address of the consumer 120, a social security number of the consumer 120, employment information (e.g., name and address of employer, length of employment, salary, etc.), assets (e.g., investments), liabilities (e.g., mortgage, car loan, etc.), past credit history, length of credit history, repayment history, and other information used by a lender to determine whether to provide financing to the consumer 120.

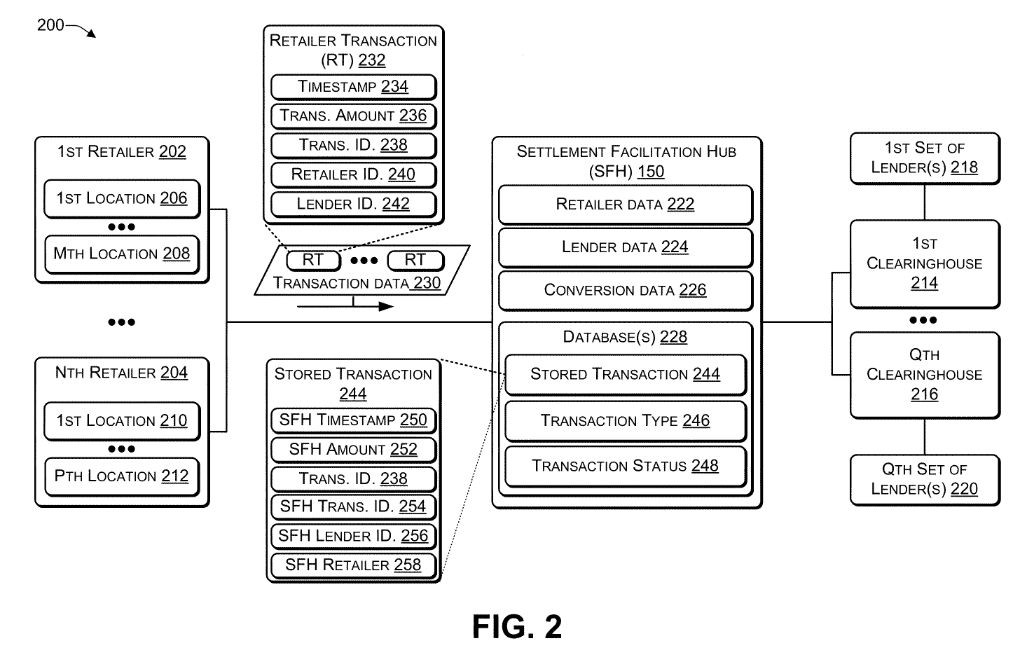

The consumer data 122 (e.g., the filled in prequalification template 121) may be sent from the computing device 102 (or using the interface 118) to a representative primary lender 108. While one primary lender is illustrated in FIG. 1, in some implementations, more than one primary lender may be used. The primary lender 108 may determine a metric 124, such as a FICO score or other similar metric, based on the consumer data 122. For example, the primary lender 108 may determine the metric 124 using a consumer reporting agency, such as Equifax®, Experian®, TransUnion®, or other agency. The primary lender 108 may compare the metric 124 and the consumer data 122 with one or more primary thresholds 126. For example, the primary thresholds 126 may specify various criteria that the primary lender 108 uses to determine whether to invite the consumer 120 to apply for financing, such as length of employment criteria, salary criteria, asset criteria, liability criteria, past credit history criteria, length of credit history criteria, repayment history criteria, etc. If the metric 124 and the consumer data 122 satisfy (e.g., is greater than or equal to) the primary thresholds 126, then the primary lender 108 may provide an answer 128 that includes an invitation to apply for financing to the consumer 120. In response to determining that the answer 128 includes an invitation to apply for financing to the consumer 120, the computing device 102 may initiate providing an appropriate eDOC (e.g., a template), as discussed in more detail in FIG. 2.

If the metric 124 and the consumer data 122 to do not satisfy (e.g., is less than) the primary thresholds 126, then the primary lender 108 may provide the answer 128 indicating that the primary lender 108 declines to provide an invitation to apply for financing to the consumer. The answer 128 may include the metric 124, the consumer data 122, derived data 130 that was derived from the metric 124, or any combination thereof. In some cases, the derived data 130 may specify a particular range within which the metric 124 falls. For example, when the metric 124 is between A and B (where A and B are integers and A is not equal to B), the derived data 130 may indicate that the metric 124 is within a first band, when the metric 124 is between B−1 and C, the derived data 130 may indicate that the metric 124 is within a second range, etc. To illustrate, when the metric 124 is between 800 and 750, the derived data 130 may indicate that the metric 124 falls within a first range, when the metric 124 is between 749 and 700, the derived data 130 may indicate that the metric 124 falls within a second range, and so on.

In response to determining that the answer 128 indicates that the primary lender 108 has declined to provide an invitation to apply for financing to the consumer 120, the computing device 102 (or the interface 118) may automatically (e.g., without human interaction) retrieve the derived data 130 from the answer 128 and automatically provide the derived data 130 and the consumer data 122 to the credit bureau 106. Because the computing device 102 (or the interface 118) automatically sends the derived data 130 and the consumer data 122 to the credit bureau 106, the consumer 120 may be unaware that the primary lender 108 declined to provide an invitation to apply for financing.

The credit bureau 106 may use the consumer data 122, the derived data 130, or both to determine whether to provide an invitation to apply for financing from one of the secondary lenders 110. The secondary lenders 110 may include one or more secondary lenders. In FIG. 1, N lenders, such as a first lender 132 to an Nth lender 134 (where N>1), are illustrated. Each of the lenders 132 to 134 may have a corresponding scorecard (e.g., a scoring algorithm and criteria) which the credit bureau 106 uses to determine whether to provide an offer of financing to the consumer 120. In this example, scorecards 136 may include N scorecards corresponding to each of the N lenders 132 to 134. Each of the N scorecards 136 may include criteria provided by each of the N lenders 132 to 134.

The credit bureau 106 may use the scorecards 136 (e.g., scoring algorithms and criteria) to determine whether to provide an invitation to apply for financing. The scorecards 136 may include criteria, such as criteria for the metric 124, length of employment criteria, salary criteria, asset criteria, liability criteria, past credit history criteria, length of credit history criteria, repayment history criteria, etc. The scorecards 136 may use the consumer data 122, the derived data 130, or both to determine whether to provide an invitation to apply for financing to the consumer 120. The credit bureau 106 may use the corresponding scorecards 136 to determine whether the consumer 102 qualifies for zero, one, or M offers 138 to 140 (M>0). If the consumer 102 qualifies for zero offers, a result 142 may be sent to the computing device 102 indicating that prequalification has been completed and no invitations to apply for financing are available. If the consumer 102 qualifies for one offer from the lenders 132 to 134, the result 142 may identify an offer (e.g., the Mth offer 140 where M=1) provided by one of the secondary lenders 132 to 134 and the consumer 120 may be invited to apply for financing from the secondary lender corresponding to the offer. If there are two or more offers (e.g., M>1), then an arbitration algorithm 144 may select from one of the offers 138 to 140. In some cases, when M>1, an agent 146 of the credit bureau 106 or the arbitration algorithm 144 may select one of the offers 138 to 140. For example, the agent 146 may be Zoot® or another similar automated agent. The agent 146 or the arbitration algorithm 144 may select one of the offers 138 to 140 based on one or more factors, such as a size of the credit limit offered, an interest rate offered, a type of payment plan offered, other information associated with the offers 138 to 140, or any combination thereof.

If the result 142 (or the answer 128) includes an invitation to apply for financing from a lender (e.g., from the primary lender 108 or from one of the secondary lenders 110), the computing device 102 (or the interface 118) may retrieve a template associated with the lender to create a disclosure for the consumer 120 to complete (e.g., by signing). A disclosure may refer to a template of an application for financing that has been filled in with consumer data (e.g., name, address, social security number, and the like). The template may be prefilled with at least a portion of the consumer data 122 to create the disclosure. In some cases, the template may request additional consumer data associated with the consumer 120. For example, the consumer data 122 may correspond to criteria (e.g., the primary thresholds 126) used by the primary lender 108 and at least one of the secondary lenders 110 may have additional criteria. For example, one of the secondary lenders 110 may lend to those with past military service. In this example, the template used by the second lender 110 may request additional consumer data related to the military service of the consumer 120. The disclosure associated with a particular offer may be created using a disclosure system 148. The disclosure system 148 may include templates associated with each lender and may be used to create a disclosure for the consumer 120. A digital representation of the signed disclosure may be stored by the disclosure system 148. The disclosure system 148 may comprise a computer-based device that includes one or more processors and one or more computer-readable media storing instructions that are executable by the one or more processors to perform various functions.

After the consumer 120 has signed a disclosure, the consumer 120 may be authorized to make purchases from the retailer 114 up to a certain dollar amount, which is also known as a credit limit. The credit limit may be specified in the disclosure and may indicate a maximum amount for which the lender is willing to authorize financing for a purchase. For example, when the credit limit is $1200, the consumer 120 may initiate one or more purchases at the retailer 114, and the lender may approve financing the purchases as long as the total amount of the one or more purchases does not exceed $1200. If a particular purchase would cause the total amount of the financing to exceed $1200, the lender may decline to authorize financing the particular purchase. After the consumer 120 has initiated a transaction to finance and purchase an item at the retailer 114 and the lender has approved the financing, from the perspective of the retailer 114, the transaction has not been completed because the retailer 114 has yet to receive the funds from the lender. To receive the funds from the lender and settle the transaction, the retailer 114 may use a settlement facilitation hub (SFH) 150.

The SFH 150 may be connected to the network 112 or an alternate network that connects the retailer 114 and the SFH 150. By using the facilitation hub 150, the retailer 114 may avoid communicating with more than one lender from the lenders 108 and 110. For example, the retailer 114 may provide transaction data that includes information associated with one or more transactions to the SFH 150. The transaction data may be sent in a particular format associated with the SFH 150. The SFH 150 may extract the individual transactions from the transaction data, associate a transaction status with each transaction, and store each transaction within the SFH 150. The SFH 150 may determine a lender associated with each transaction and may determine a clearinghouse associated with each lender. The SFH 150 may create settlement transaction data that includes portions of the transaction data. The settlement transaction data may be formatted for receipt by a clearinghouse used by one or more lenders. The SFH 150 may provide the settlement transaction data to the clearinghouse. In response to receiving the settlement transaction data, the clearinghouse may initiate the transfer of funds to retailer accounts from the accounts of lenders associated with the clearinghouse. Each clearinghouse may provide transaction results to the SFH 150 indicating whether each transaction (e.g., transfer of funds to the retailer's account) was successful or not. The SFH 150 may update the status of the transactions stored in the SFH 150 based on the transaction results. The SFH 150 may prepare and provide a settlement report to each retailer, indicating a status of the retailer's transactions, and details associated with each transaction, such as an amount of funds successfully transferred to the retailer account, a total amount of funds transferred, etc. Each lender is associated with a single clearinghouse. Thus, transactions associated with a particular lender will be processed by a clearinghouse that is associated with the lender.

Thus, the consumer 120 may provide information (e.g., consumer data 122) when invited to apply for financing from one or more primary lenders (e.g., the primary lender 108). If the consumer 120 does not receive an offer of financing from the primary lenders, the information may be provided to one or more secondary lenders 110. If the secondary lenders 110 provide more than one offer, one of the offers may be selected using an arbitration scheme (e.g., arbitration 144). In this way, instead of just one lender, multiple lenders may be used to select an offer of financing to the consumer 120. To avoid the cost and complexity to communicate in a lender-specific or clearinghouse-specific format with multiple lenders, the retailer 114 may use the SFH 150. The SFH 150 may decouple the retailer 114 from the clearinghouses and from the lenders.

FIG. 2 is an illustrative architecture 200 of a settlement facilitation hub in which transaction data is received from one or more retailers according to some implementations. One or more retailers may use the SFH 150 to access multiple lenders. For example, as illustrated in FIG. 2, N retailers (N>1), such as a first retailer 202 to an Nth retailer 204 may communicate (e.g., via a network) with the SFH 150. The retailers 202 to 204 may include the retailer 114 of FIG. 1. Each of the retailers 202 to 204 may have one or more locations. As illustrated in FIG. 2, the first retailer 202 may have M locations (M>1, M may or may not be equal to N), such as a first location 206 and an Mth locations 208. The Nth retailer 204 may have P locations (P>1), P may or may not be equal to N or M), such as a first location 210 and a Pth location 212.

The SFH 150 may enable the retailers 202 to 204 to access multiple lenders via one or more clearinghouses. As illustrated in FIG. 2, the SFH 150 may enable the retailers 202 to 204 to access multiple lenders using Q clearinghouses (Q>1, Q may or may not be equal to N, M, or P), such as a first clearinghouse 214 to a Qth clearinghouse 216. Each of the clearinghouses 214 to 216 may be associated with a set of one or more lenders. As used herein, the term “set of X” refers to one or more of X. For example, the first clearinghouse 214 may be associated with a first set of (e.g., one or more) lenders 218 and the Qth clearinghouse 216 may be associated with a Qth set of (e.g., one or more) lenders 220. Each of the sets of lenders 218 to 220 may include one or more primary lenders (e.g., the primary lender 108 of FIG. 1), one or more secondary lenders (e.g., the secondary lenders 110), or both primary lenders and secondary lenders.

The SFH 150 may include retailer data 222 that includes information associated with each of the retailers 202 to 204. For example, the retailer data 222 may identify a format in which the retailer transmits transaction data, a format used by the retailer to receive settlement reports, and other retailer-related information. The SFH 150 may include lender data 224 that includes information associated with each of the lenders in the sets of lenders 218 to 220. For example, the lender data 224 may include a mapping of lenders to clearinghouses (e.g., which lenders are associated with each of the clearinghouses 214 to 216), a format that the lender (or the associated clearinghouse) uses to receive and/or provide data, and other lender-related information. The SFH 150 may include conversion data 226. The conversion data 226 may specify information about converting from one format to another, such as converting at least a portion of a retailer's transaction data to a data format suitable for a lender or a clearinghouse, converting at least a portion of clearinghouse data to a data format suitable for each retailer, etc. The SFH 150 may include one or more databases 228 to store (i) transactions and (ii) a status of each of the transactions.

Each retailer may periodically (e.g., at regular intervals) provide transaction data 230 that includes data from multiple retailer transactions to the SFH 150. For example, the Nth retailer 204 may provide the transaction data 230 to the SFH 150 every day, every 8 hours, every 4 hours, every hour, etc. In some cases, the Nth retailer 204 may provide the transaction data 230 after a threshold number of retailer transactions have been performed. For example, the Nth retailer 204 may provide the transaction data 230 to the SFH 150 when 1,000 retailer transactions have been performed. The transaction data 230 provided to the SFH 150 may include retailer transactions associated with one or more locations of each retailer. For example, the transaction data 230 may include data associated with retailer transactions from one or more of the locations 210 to 212 of the Nth retailer 204. The transaction data 230 may be referred to as a batch of retailer transactions and the SFH 150 may perform batch processing on the multiple retailer transactions in the transaction data 230.

As used herein, the terms “send,” receive,” “provide,” and “retrieve” may encompass a variety of communication mechanisms, such as email, file transfer protocol (FTP), secure FTP (SFTP), secure socket layer (SSL), FTP over SSL (FTPS), or other types of data exchange mechanism. In some cases, the data exchanged using email, FTP, SFTP, SSL, FTPS or another type of data exchange mechanism may be encrypted using a key or a key pair known only to the receiver and the sender. As an example of transferring data using SFTP, the transaction data 230 may be stored at a pre-determined location that is accessible to both the retailer and the SFH 150. In some cases, the SFH 150 may periodically retrieve (e.g., using SFTP) the transaction data 230 from the pre-determined location. In other cases, after storing the transaction data 230 at the pre-determined location, the retailer may provide a notification message notifying the SFH 150 that the transaction data 230 has been stored at the pre-determined location. In response to the notification message, the SFH 150 may retrieve (e.g., using SFTP) the transaction data 230 stored at the pre-determined location. While this example, uses the transaction data 230, other types of data may similarly be exchanged when referenced by the terms “send,” receive,” “provide,” or “retrieve.”

The transaction data 230 may include one or more retailer transactions, such as a representative retailer transaction 232. The retailer transaction 232 may include various information, such as a timestamp 234, a transaction amount 236, a transaction identifier 238 (the word identifier is abbreviated “Id.” in FIG. 2), a retailer identifier 240, and a lender identifier 242. The timestamp 234 may identify a date, or a date and a time when the retailer transaction 232 occurred. The transaction amount 236 may include a total amount associated with the retailer transaction 232. The transaction amount 236 may include a listing of items purchased in the retailer transaction 232, the cost of each item, sales tax costs (if applicable), shipping costs (if applicable), etc. The transaction amount 236 may identify an amount that the Nth retailer 204 is expecting to receive in the Nth retailer's account when the retailer transaction 232 is settled. The transaction identifier 238 may be an identifier that the Nth retailer 204 has associated with the retailer transaction 232. The lender identifier 242 may identify a lender associated with the retailer transaction 232.

In response to receiving the transaction data 230, the SFH 150 may retrieve each retailer transaction, such as the representative retailer transaction 232, from the transaction data 230 and store each retailer transaction in one of the databases 228. The SFH 150 may use the retailer data 222 that describes a format of the transaction data 230 to retrieve each retailer transaction from the transaction data 230. For example, the SFH 150 may retrieve the representative retailer transaction 232 from the transaction data 230 and store at least a portion of the contents of the retailer transaction 232 as a representative stored transaction 244. The SFH 150 may perform various operations on the retailer transaction, such as modifying at least a portion of the retailer transaction 232 based on the conversion data 226, to create the stored transaction 244. For example, the first retailer 202 may provide retailer transactions according to a first format and the Nth retailer 204 may provide retailer transactions according to a second format. The SFH 150 may modify each retailer transaction from the first retailer 202 and each retailer transaction from the Nth retailer 204 based on the conversion data 226 to create modified transactions to be stored in the databases 228. The modified transactions of the first retailer 202 may be in a same format as the modified transactions of the Nth retailer 204. Thus, the retailer transactions stored in the databases 228 may all be in a same format even if they are in different formats when received from the multiple retailers 202 to 204.

The SFH 150 may associate a transaction type 246 and a transaction status 248 with the stored transaction 244. The transaction type 246 may identify a type of the stored transaction 244, such as whether the transaction is a purchase, a full return for full credit, a partial return for partial credit, etc. The transaction status 248 may identify a status of the stored transaction 244 such as whether the corresponding stored transaction is cleared (e.g., the amount to be settled between the lender and the retailer has been finalized after taking into account the down payment, tax, shipping, and the like), processing (e.g., the clearinghouse associated with the lender has been sent the transaction), settled (e.g., the lender transferred the amount of funds associated with the transaction to the retailer's account), and exception (e.g., a problem was encountered and the funds were not transferred to the retailer's account). When the transaction status 248 indicates an exception occurred, the transaction status 248 may include an error code or other indicator that identifies the type of problem that was encountered when the transfer of funds was requested.

In some cases, the stored transaction 244, the transaction type 246, and the transaction status 248 may each be stored in a different database, e.g., the stored transaction 244 may be stored in a first database of the databases 228, the transaction type 246 may be stored in a second database of the databases 228, and the transaction status 248 may be stored in a third database of the databases 228. In other cases, the stored transaction 244, the transaction type 246, and the transaction status 248 may each be stored in a same database. When at least a portion of each of the retailer transactions from the transaction data 230 is stored in the databases 228 as stored transactions, and the transaction status 248 is associated with each of the stored transactions, the transaction status 248 may be set to “cleared” to indicate that the precise amount to be transferred from a lender account to a retailer account has been determined based on the information (e.g., the transaction amount 236) in each retailer transaction.

Each stored transaction in the databases 228, such as the representative stored transaction 244, may include various pieces of information. The information in the retailer transaction 232 may be used to create the stored transaction 244. In some cases, at least some of the information in the retailer transaction 232 may be the same as the corresponding information in the stored transaction 244. In other cases, at least some of the information in the stored transaction 244 may be modified portions of the retailer transaction 232. For example, the stored transaction 244 may include information, such as an SFH timestamp 250, an SFH amount 252, the retailer's transaction identifier 238, an SFH transaction identifier 254, an SFH lender identifier 256, and SFH retailer 258. The SFH timestamp 250 may include a date and/or time associated with the retailer transaction 232 and may be in a same format as the timestamp 234 or in a format that is different from the timestamp 234. For example, the SFH 150 may convert the timestamp 234 from the retailer transaction 232 into a format used by the SFH 150 to create the SFH timestamp 250. The SFH amount 252 may be the same as or different from the transaction amount 236. For example, the SFH 150 may convert at least a portion of the transaction amount 236 from the retailer transaction 232 into a format used by the SFH 150 to create the SFH amount. For example, the transaction amount 236 of the retailer transaction 232 may include a listing of items purchased in the retailer transaction, the cost of each item, sales tax costs (if applicable), shipping costs (if applicable) whereas the SFH amount 252 may include the total amount to be transferred from a lender's account to the retailer's account as part of the settlement process. The transaction identifier 238 may be the identifier that the Nth retailer 204 has assigned to the retailer transaction 232 that corresponds to the stored transaction 244. The transaction identifier of the stored transaction 244 may be used later to reference the retailer transaction 232 in a settlement report. The SFH transaction identifier 254 may be an identifier assigned by the SFH 150 to the stored transaction 244. The lender identifier 242 from the retailer transaction 232 may be an identifier that the Nth retailer 204 uses to identify the lender associated with the retailer transaction 232. The SFH lender identifier 256 may be an identifier that the SFH 150 uses to identify a lender to one of the clearinghouses 214 to 216. In some cases, the SFH lender identifier 256 may be the same as the lender identifier 242 while in other cases the SFH lender identifier 256 may be different from the lender identifier 242. For example, the SFH 150 may extract the lender identifier 242 from the retailer transaction 232 and convert it to the SFH lender identifier 256 using the lender data 224 and/or the conversion data 226. The SFH retailer 258 may identify the retailer associated with a retailer transaction corresponding to a stored transaction. For example, the SFH retailer 258 may identify that the stored transaction 244 is associated with the Nth retailer 204 associated with the retailer transaction 232. The SFH retailer 258 may be used to identify stored transactions that are associated with a particular retailer when creating a settlement report for the particular retailer.

Thus, multiple retailers 202 to 204 may each provide transaction data, such as the transaction data 230, to the SFH 150. The transaction data 230 may include multiple (e.g., a batch of) retailer transactions. The SFH 150 may extract retailer transactions from the transaction data and modify at least a portion of the retailer transactions to create modified transactions that are stored in the SFH 150 as stored transactions. The SFH 150 may modify the retailer transactions to create the stored transactions using the conversion data 226. Thus, transaction data from multiple retailers that uses different formats may be converted to a common format and stored as the stored transactions. The transaction data 230 may include retailer transactions in a format that is understandable to the retailer. The term understandable as used herein refers to the ability of the receiving computer system to receive, interpret, and respond to the data or information that is received. The stored transactions 244 may include transaction information in a format that is understandable to the SFH 150. In this way, the SFH 150 decouples the clearinghouses 214 to 216 and lenders 218 to 220 from the retailers 202 to 204.

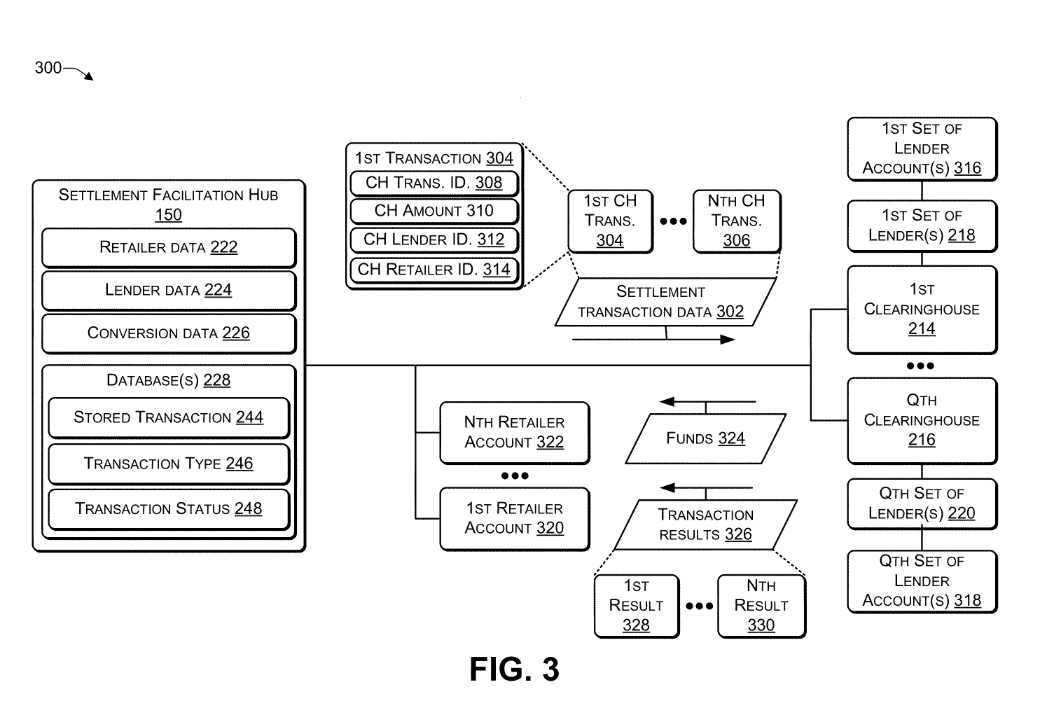

FIG. 3 is an illustrative architecture 300 of a settlement facilitation hub in which settlement transaction data is provided to one or more clearinghouses according to some implementations. After receiving retailer transactions and storing them as stored transactions in the databases 228, the SFH 150 may create and provide settlement transaction data 302 to one of the clearinghouses 214 to 216. For example, the settlement transaction data 302 may be provided using email (e.g., in which the contents are encrypted), FTP, SFTP, or another type of communication mechanism. For example, the SFH 150 may store the settlement transaction data 302 at a pre-determined location and then send a notification message to a clearinghouse. In response to receiving the notification message, the clearinghouse may retrieve (e.g., using SFTP) the settlement transaction data 302.

The settlement transaction data 302 may include multiple transactions, such as a first clearinghouse (CH) transaction 304 to an Nth CH transaction 306 (where N>1). The CH transactions 304 to 306 may include transactions from more than one retailer. The CH transactions 304 to 306 may be associated with a particular clearinghouse (e.g., one of the clearinghouses 214 to 216) and thus a particular set of lenders. For example, the SFH 150 may group transactions associated with a particular clearinghouse based on the set of lenders associated with the particular clearinghouse. To illustrate, the SFH 150 may send the settlement transaction data 302 to the Qth clearinghouse 216 by grouping together the CH transactions 304 to 306 that are associated with the Qth set of lenders 220.

Each of the CH transactions 304 to 306 may include various types of information. For example, the first CH transaction 304 may include a CH transaction identifier 308, a CH amount 310, a CH lender identifier 312, and a CH retailer identifier 314. In FIG. 3, clearinghouse is abbreviated “CH,” transaction is abbreviated “Trans.,” and identifier is abbreviated “ID.” The CH transaction identifier 308 may be used to identify the transaction to the Qth clearinghouse 216. The CH amount 310 may indicate an amount associated with the transaction, e.g., the amount to be transferred from the lender to the retailer as part of the settlement. The CH lender identifier 312 may identify a specific lender of the Qth set of lenders 220 from which to transfer the CH amount 310. The CH retailer identifier 314 may identify the retailer to which the clearing house should transfer the CH amount 310. The SFH 150 may create the first CH transaction 304 that includes the CH transaction identifier 308, the CH amount 310, the CH lender identifier 312, and the CH retailer identifier 314 based on the stored transaction 244 using the conversion data 226 of FIG. 2. For example, the SFH 150 may, based on the conversion data 226 of FIG. 2, perform one or more mappings, such as mapping (e.g., converting) the transaction identifier 238 to the CH transaction identifier 308, mapping the SFH lender identifier 256 to the CH lender identifier 312, or mapping the SFH retailer 258 to the CH retailer identifier 314. These mappings (e.g., conversions) may create the settlement transaction data 302 in a format that is associated with a particular clearinghouse (e.g., the Qth clearinghouse 216) and may enable the particular clearinghouse to initiate the settlement process based on the settlement transaction data 302.

The CH transaction identifier 308 may be based on the SFH transaction identifier 254 of FIG. 2, the CH amount 310 may be based on the SFH amount 252, the CH lender identifier 312 may be based on the SFH lender identifier 256, and the CH retailer identifier 314 may be based on the SFH retailer 258. In some cases, the CH transaction identifier 308 may be the same as the SFH transaction identifier 254 of FIG. 2, the CH amount 310 may be the same as the SFH amount 252, the CH lender identifier 312 may be the same as the SFH lender identifier 256, the CH retailer identifier 314 may be the same as the SFH retailer 258, or any combination thereof. In other cases, the CH transaction identifier 308 may be mapped (e.g., using the conversion data 226) from the SFH transaction identifier 254 of FIG. 2, the CH amount 310 may be mapped from the SFH amount 252, the CH lender identifier 312 may be mapped from the SFH lender identifier 256, the CH retailer identifier 314 may be mapped from the SFH retailer 258, or any combination thereof.

When the SFH 150 is creating the settlement transaction data 302 from the stored transactions in the databases 228, the SFH 150 may set the transaction status 236 to “processing” for each stored transaction that corresponds to one of the CH transactions 304 to 306.

In response to receiving the settlement transaction data 302, one of the clearinghouses 214 to 216 may initiate a transfer of funds from one or more lender accounts to one or more retailer accounts. Each lender may have an associated financial account. For example, the first set of lenders 218 may have a corresponding first set of lender accounts 316 and the Qth set of lenders 220 may have a corresponding Qth set of lender accounts 318. To illustrate, the Qth set of lender accounts 318 may include a first lender account associated with a first lender of the Qth set of lenders 220, a second lender account associated with a second lender of the Qth set of lenders 220, and so on. Each retailer may also have a corresponding financial account. For example, the first retailer 202 of FIG. 2 may have a corresponding first retailer account 320 and the Nth retailer 204 may have a corresponding Nth retailer account 322. Based on the earlier example from FIG. 2 (e.g., in which the Nth retailer 204 sends the transaction data 230), in response to receiving the settlement transaction data 302, the Qth clearinghouse 216 may initiate a transfer of funds 324 from one of the Qth set of lender accounts 318 to the Nth retailer account 322 to settle the retailer transaction 232. The Qth clearinghouse 216 may initiate a transfer of funds for each of the CH transactions 304 to 306 included in the settlement transaction data 302.

The transfer of funds 324 may take into account fees associated with promotions and/or discounts. When one of the clearinghouses 214 to 216 processes one of the CH transactions 304 to 306, the clearinghouse may adjust the amount of the funds 324 to be transferred based on fees associated with applicable promotions and/or discounts. For example, a retailer may pay a fee to a lender to provide a “no interest if minimum monthly payments are made for X months” promotion. As another example, for each loan provided by a lender, a retailer may pay the lender a fee. The transaction amount, less the lender's fee, may be the discounted transaction amount that is transferred from the lender's account to the retailer's account. To illustrate, a retailer may pay a lender a flat fee, a percentage of each transaction, or a graduated percentage (e.g., 10% of the first $1000 and 5% of the rest of the transaction) for each transaction. The amount that is transferred from the lender's account to the retailer's account may take into account the lender's fee. Thus, for a $1000 transaction in which the lender is paid 10%, the discounted amount of $900 may be transferred to the retailer's account to settle the transaction.

After initiating the transfer of funds in response to receiving the settlement transaction data 302, a clearinghouse may determine a result of initiating the transfer of funds (e.g., whether the funds were successfully transferred) and provide transaction results 326 to the SFH 150. For example, in response to receiving the settlement transaction data 302, the Qth clearinghouse 216 may initiate a transfer of funds from one of the Qth set of lender accounts 318 to one of the retailer accounts 320 to 322 for each of the CH transactions 304 to 306. The Qth clearinghouse 216 may determine a result of initiating the transfer of funds from one of the Qth set of lender accounts 318 to one of the retailer accounts 320 to 322 for each of the CH transactions 304 to 306. For example, the Qth clearinghouse 216 may determine a first result 328 associated with initiating a transfer of funds based on the first CH transaction 304 and determine an Nth result 330 associated with initiating a transfer of funds based on the Nth transaction 306. The Qth clearinghouse 216 may include the results 328 to 330 in the transaction results 326. The results 328 to 330 may indicate whether a fund transfer between a lender account and a retailer account was successfully completed (e.g., settled) and if the fund transfer was unsuccessful, the results 328 to 330 may indicate that an exception occurred. In some cases, when an exception occurs, the corresponding results 328 to 330 may include an error code identifying the type of problem that was encountered.

Thus, the SFH 150 may provide settlement transaction data that includes information associated with one or more transactions to a clearinghouse that is associated with lenders that are associated with the one or more transactions. The clearinghouse may process each of the one or more transactions by initiating a transfer of funds from a lender account to a retailer account for each transaction. The clearinghouse may determine a result of initiating the transfer of funds, e.g., whether the funds were successfully transferred and if they were not transferred, what type of problem (e.g., error) occurred, and provide the results of initiating the transfer of funds for each transaction to the SFH 150. For example, for the first CH transaction 304, the Qth clearinghouse 216 may initiate the transfer of the funds 234 from the account in the Qth set of lender accounts 318 that is associated with the CH lender identifier 312. An amount of the funds 324 that are transferred may be determined based on the CH amount 310. The funds 324 may be transferred to one of the retailer accounts 320 to 322 that is determined based on the CH retailer identifier 314. The Qth clearinghouse 216 may determine the first result 328 of initiating the transfer of the funds 324 from an account associated with the CH lender identifier 312 to an account associated with the CH retailer identifier 314 based on the first CH transaction 304.

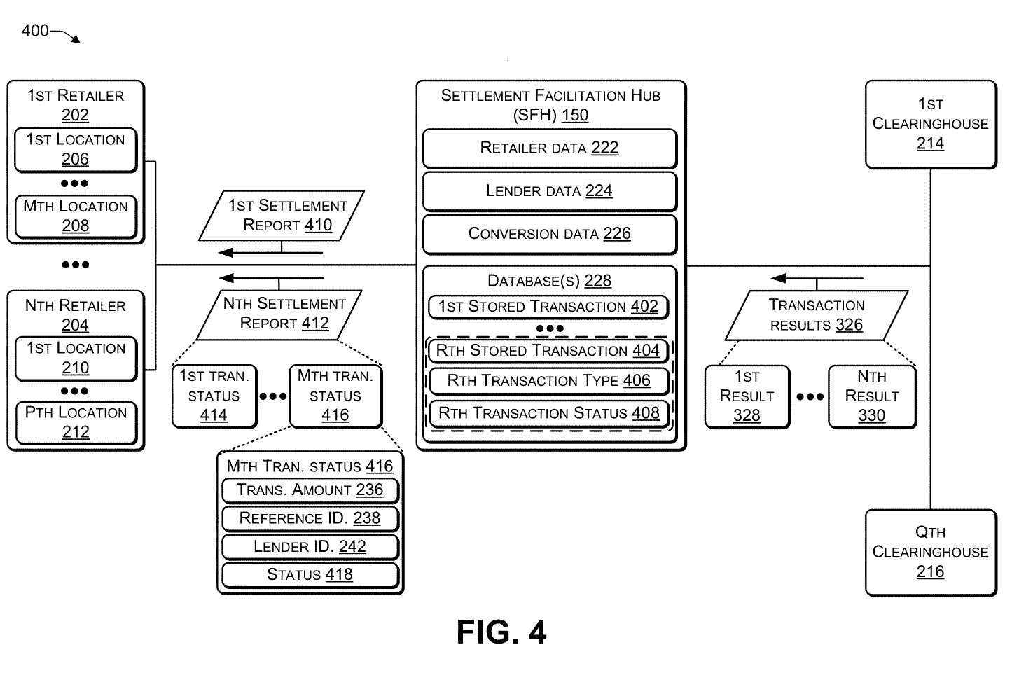

FIG. 4 is an illustrative architecture 400 of a settlement facilitation hub in which a settlement report is sent to one or more retailers according to some implementations. The SFH 150 may receive the transaction results 326 from one of the clearinghouses 214 to 216. The transactions results 326 may include results associated with initiating the transfer of funds from lender accounts to retailer accounts. For example, the transaction results 326 may include a first result 328 to an Nth result 330 (where N>1). The results 328 to 330 may be associated with at least a portion of the stored transactions in the one or more databases 228. For example, the databases 228 may include a first stored transaction 402 to an Rth stored transaction 404 (where R>1) associated with one or more of the retailers 202 to 204.

In response to receiving the transaction results 326, the SFH 150 may update the settlement status of the stored transactions 402 to 404, e.g., that correspond to the CH transactions 304 to 306 of FIG. 3, based on the results 328 to 330. For example, the Rth transaction 404 may have an associated Rth transaction type 406 and and Rth transaction status 408. The SFH 150 may update the Rth transaction status 408 based on the corresponding result from the results 328 to 330. To illustrate, if an Rth result indicates that the Rth stored transaction 404 was successfully settled, then the SFH 150 may update the Rth transaction status 408 to “settled.” If the Rth result indicates that the Rth stored transaction 404 was not settled, then the SFH 150 may update the Rth transaction status 408 to “exception.” In some cases, if a result (e.g., one of the results 328 to 330) includes an error code provided by one of the clearinghouses 214 to 216, the SFH 150 may include the error code when updating the transaction status to “exception.”

After updating the status of the stored transactions 402 to 404, the SFH 150 may prepare a settlement report for one or more of the retailers 202 to 204. A settlement report sent to a particular retailer may include information of each transaction associated with the particular retailer. For example, the SFH 150 may provide a first settlement report 410 to the first retailer 202. The SFH 150 may provide an Nth settlement report 412 to the Nth retailer 204. For example, if M transactions are associated with the Nth retailer 204, then the Nth settlement report 412 may include a transaction status of each of the M transactions. The Nth settlement report 412 may include a first transaction status 414 to an Mth transaction status 416 for each of the M transactions associated with the Nth retailer 204.

Each settlement report may include at least a portion of the information sent by the retailer in the retailer transaction to enable the retailer to identify the transaction. The transaction status in each settlement report may identify the transaction based on the retailer's reference identifier. For example, the Mth transaction status 416 may include the reference identifier 242 that identifies the retailer transaction 232 of FIG. 2. The Mth transaction status 416 may include the lender identifier 242 from the retailer transaction 232. The Mth transaction status 416 may include the transaction amount 236 from the retailer transaction 232. The Mth transaction status 416 may include a status 418 indicating whether the transaction amount 236 was successfully transferred (e.g., “settled”) from an account of the lender associated with the lender identifier 242 to the Nth retailer account 322 of the Nth retailer 204 or whether an exception occurred. If an exception occurred, the settlement report may include an error code or error message in a format that the retailer is capable of understanding. For example, the SFH 150 may map an error code provided by a clearinghouse to an error message that the retailer is capable of understanding.

Thus, the SFH 150 may receive transaction results from a clearinghouse. The transaction results may include results of initiating one or more transfers of funds from lender accounts to retailer accounts. The SFH 150 may update the status (e.g., the transaction status, the settlement status, or both) of at least a portion of the stored transactions based on the transaction results. The SFH 150 may periodically prepare a settlement report for each retailer. The settlement report for a particular retailer may include an update of at least a portion of the stored transactions that are associated with the particular retailer. Each settlement report may include the retailer's reference identifier for the transaction and other retailer-related information. For example, the SFH 150 may create the settlement reports based on the retailer data 222, the lender data 224, and the conversion data 226. In this way, each retailer is provided an update associated with stored transactions of each retailer without being aware of the details regarding the settlement process. In this way, the retailers 202 to 204 may be decoupled from the clearinghouses 214 to 216 and the transaction results 326.

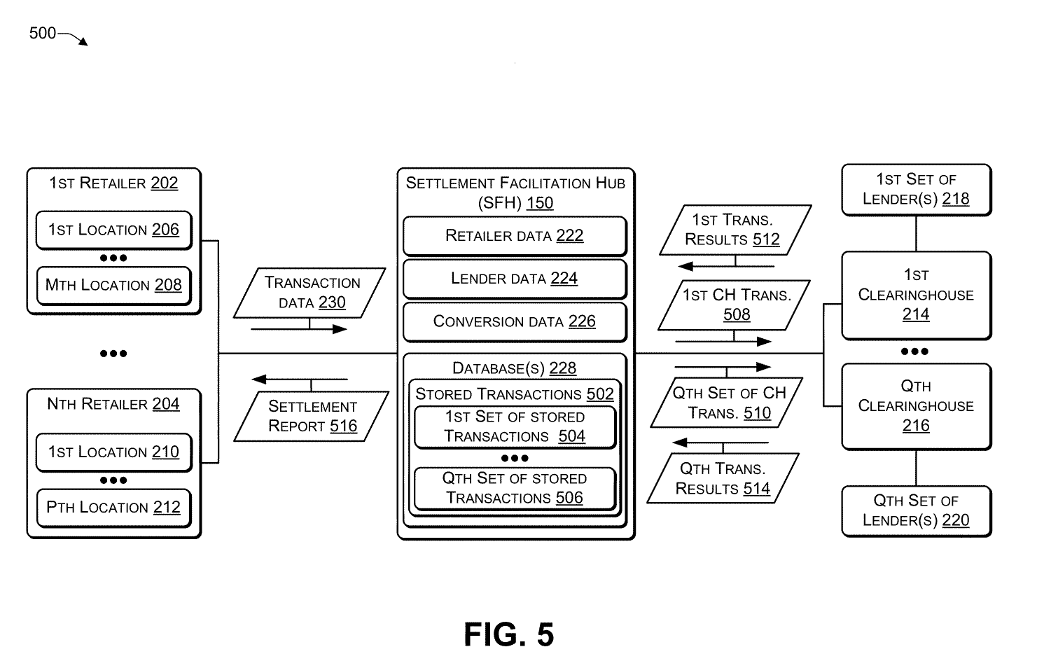

FIG. 5 is an illustrative architecture 500 of a settlement facilitation hub in which settlement transaction data is sent to two or more clearinghouses according to some implementations. One or more of the retailers 202 to 204 may provide transaction data (e.g., the transaction data 230) to the SFH 150 and request that the SFH 150 facilitate settlement of the retailer transactions in the transaction data 230. The SFH 150 may process the retailer transactions in the transaction data and store transactions in the databases 228 corresponding to the retailer transactions. Thus, in response to receiving the transaction data 230, the SFH 150 may create stored transactions 502.

Based on the lender identifier (e.g., the SFH lender identifier 256 of FIG. 2) of each of the stored transactions 502, the SFH 150 may create CH transactions to provide to one of the clearinghouses 214 to 216. For example, the SFH 150 may identify, based on the lender identifier of each of the stored transactions 502, a first set of stored transactions 504 that are associated with the first set of lenders 218. The SFH 150 may determine, based on the lender data 224, that the first set of lenders 218 are associated with the first clearinghouse 214. The SFH 150 may create the first set of CH transactions 508 based on the first set of stored transactions 504. The SFH 150 may provide the first set of CH transactions 508 to the first clearinghouse 214.

The SFH 150 may identify, based on the lender identifier of each of the stored transactions 502, a Qth set of stored transactions 506 (where Q>1) that are associated with the Qth set of lenders 220. The SFH 150 may determine, based on the lender data 224, that the Qth set of lenders 220 are associated with the Qth clearinghouse 216. The SFH 150 may create the Qth set of CH transactions 510 based on the Qth set of stored transactions 506. The SFH 150 may provide the Qth set of CH transactions 510 to the Qth clearinghouse 216.

In response to receiving the first set of CH transactions 508, the first clearinghouse 214 may initiate a transfer of funds from lender accounts associated with the first set of lenders 218 to retailer accounts of retailers specified by each of the transactions in the first set of CH transactions 508. The first clearinghouse 214 may determine a result of initiating the transfer of funds for each transaction in the first set of CH transactions 508. For example, the result may be “settled” if the funds were successfully transferred and the result may be “exception” if the transfer was unsuccessful. The first clearinghouse 214 may provide a first set of transaction results 512 that includes the result of initiating the transfer of funds for each transaction in the first set of CH transactions 508. In response to receiving the first set of transaction results 512, the SFH 150 may update a transaction status (e.g., the transaction status 248 of FIG. 2) for each transaction in the first set of stored transactions 504.

In response to receiving the Qth set of CH transactions 510, the Qth clearinghouse 216 may initiate a transfer of funds from lender accounts associated with the Qth set of lenders 220 to retailer accounts of retailers specified by each of the transactions in the Qth set of CH transactions 510. The Qth clearinghouse 216 may determine a result of initiating the transfer of funds for each transaction in the Qth set of CH transactions 510. For example, the result may be “settled” if the funds were successfully transferred and the result may be “exception” if the transfer was unsuccessful. The Qth clearinghouse 216 may provide a Qth set of transaction results 514 that includes the result of initiating the transfer of funds for each transaction in the Qth set of CH transactions 510. In response to receiving the Qth set of transaction results 514, the SFH 150 may update a transaction status (e.g., the transaction status 248 of FIG. 2) for each transaction in the Qth set of stored transactions 506.

The SFH 150 may create a settlement report, such as a settlement report 516, for at least one of the retailers 202 to 204. For example, the SFH 150 may identify (e.g., based on the SFH retailer 258) at least a portion of the stored transactions 502 associated with a particular retailer of the retailers 202 to 204, create the settlement report 516 based on the stored transactions 502 that are associated with the particular retailer, and provide the settlement report 516 to the particular retailer.

FIG. 6 is an illustrative architecture 600 of a settlement facilitation hub in which transaction data is received from two or more retailers according to some implementations. As illustrated in FIG. 6, the first retailer 202 may provide first transaction data 602 to the SFH 150 and the Nth retailer 204 may provide Nth transaction data 604 to the SFH 150. Each of the transaction data 602 to 604 may include retailer transactions, as described with respect to the transaction data 230 of FIG. 2.

In response to receiving (or retrieving) the first transaction data 602, the SFH 150 may create a first set of stored transactions 606 based on the retailer transactions included in the first transaction data 602. In response to receiving (or retrieving) the Nth transaction data 604, the SFH 150 may create an Nth set of stored transactions 608 based on the retailer transactions included in the Nth transaction data 604.

Based on the lender identifier (e.g., the SFH lender identifier 256 of FIG. 2) of each of the stored transactions 502, the SFH 150 may create CH transactions 610 to provide to one of the clearinghouses 214 to 216. For example, the SFH 150 may identify, based on the lender identifier of each of the stored transactions 502, a portion of the stored transaction 502 that are associated with the Qth set of lenders 220. The SFH 150 may determine, based on the lender data 224, that the Qth set of lenders 220 are associated with the Qth clearinghouse 216. The SFH 150 may create the CH transactions 610 based on a portion of the stored transactions 502 that are associated with the Qth set of lenders 220. The SFH 150 may provide the CH transactions 610 to the Qth clearinghouse 216.

In response to receiving (or retrieving) the CH transactions 610, the Qth clearinghouse 216 may initiate a transfer of funds from lender accounts (e.g., the Qth set of lender accounts 318) associated with the Qth set of lenders 220 to retailer accounts of retailers identified in each of the CH transactions 610. The Qth clearinghouse 216 may determine a result of initiating the transfer of funds from the lender accounts of the Qth set of lenders 220 to retailer accounts of the retailers identified in each of the CH transactions 610 and create transaction results 612. The Qth clearinghouse 216 may provide the transaction results 612 to the SFH 150. The SFH 150 may update at least a portion of the stored transactions 502 based on the transaction results 612.

The SFH 150 may create a settlement report for one or more of the retailers 202 to 204. For example, the SFH 150 may identify (e.g., based on the SFH retailer 258) the first stored transactions 606 that are associated with the first retailer 202, create the first settlement report 410 based on the first set of stored transactions 606 that are associated with the first retailer 202, and provide the first settlement report 410 to the first retailer 202. The SFH 150 may identify (e.g., based on the SFH retailer 258) the Nth set stored transactions 608 that are associated with the Nth retailer 204, create the Nth settlement report 412 based on the Nth set of stored transactions 608 that are associated with the first retailer 202, and provide the Nth settlement report 412 to the Nth retailer 204.

### Example Process

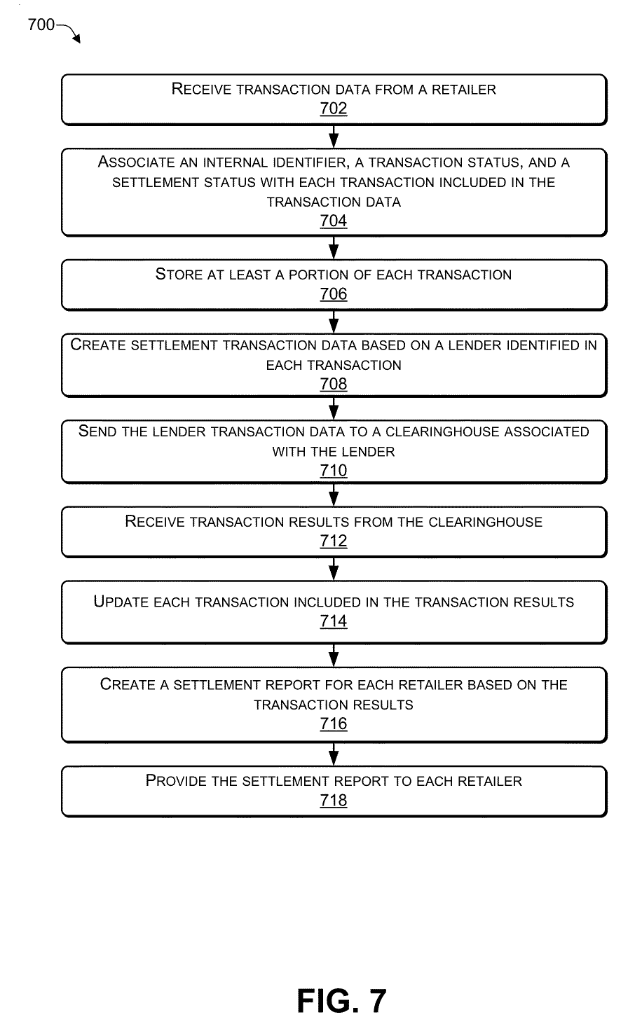

In the flow diagrams of FIGS. 7, 8, and 9 each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 700, 800, and 900 described with reference to the architectures 100, 200, 300, 400, 500, and 600 as described above, although other models, frameworks, systems and environments may be used to implement these processes.

FIG. 7 is a flow diagram of an example process 700 that includes creating settlement transaction data based on transaction data and conversion data according to some implementations. The process 700 may be performed by the SFH 150 of FIGS. 1, 2, 3, 4, 5, and 6.

At 702, transaction data may be received from a retailer. At 704, an internal identifier, a transaction status, and a settlement status may be associated with each transaction included in the transaction data. At 706, at least a portion of each transaction may be stored. For example, in FIG. 2, the SFH 150 may receive transaction data 230 that includes information associated one or more retailer transactions, such as a representative retailer transaction 232. The SFH 150 may store at least a portion of the retailer transaction 232 as the stored transaction 244. The SFH 150 may associate the transaction type 246 and the transaction status 248 with the stored transaction 244.

At 708, settlement transaction data may be created based on a lender identified in each transaction. At 710, the settlement transaction data may be sent to a clearinghouse associated with the lender. For example, in FIG. 3, the SFH 150 may create the settlement transaction data 302 that includes one or more transactions, such as the CH transactions 304 to 306. The CH transactions 304 to 306 may be included in the settlement transaction data 302 because the lenders associated with the CH transactions 304 to 306 use the same clearinghouse. For example, if the settlement transaction data 302 is sent to the Qth clearinghouse 216, the lenders associated with the CH transactions 304 to 306 may be included in the Qth set of lenders 220 associated with the Qth clearinghouse 216.

At 712, transaction results may be received from the clearinghouse. For example, in FIG. 3, after a clearinghouse received the settlement transaction data, the clearinghouse may initiate a transfer of funds from a lender account to a retailer account for each of the CH transactions 304 to 306 in the settlement transaction data 302. The clearinghouse may determine a result associated with initiating the transfer of funds for each of the CH transactions 304 to 306 and create the transaction results 326 that include the results 328 to 330.

At 714, each transaction included in the transaction results may be updated. At 716, a settlement report for each retailer may be created based on the transaction results. At 718, the settlement report may be provided to each retailer. For example, in FIG. 4, in response to receiving the transaction results 326, the SFH 150 may update one or more of the stored transactions in the databases 228. The SFH 150 may update one or more of the stored transactions 402 to 404 based on the transaction results. After one or more of the stored transactions 402 to 404 have been updated, the SFH 150 may create a settlement report for one or more retailers based on the updated status of the stored transactions 402 to 404. For example, the SFH 150 may provide the settlement reports 410 to 412 to the retailers 202 to 204 using email, file transfer protocol (FTP), secure FTP (SFTP), or other communications mechanism (e.g., either a push mechanism or a pull mechanism).

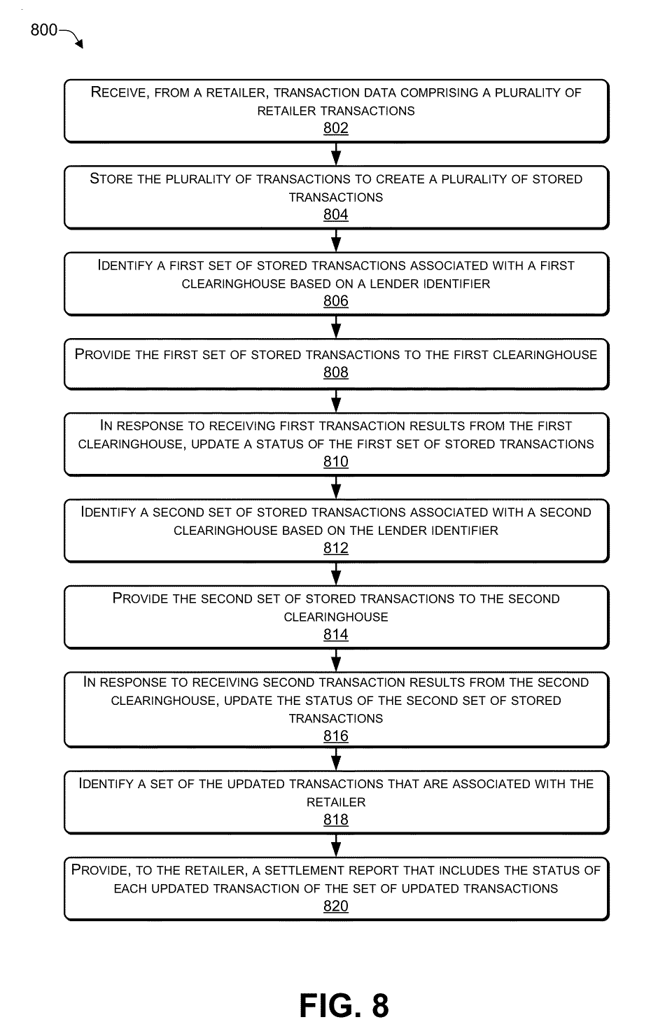

FIG. 8 is a flow diagram of an example process 800 that includes identifying a first set of transactions associated with a first clearinghouse and a second set of transactions associated with a second clearinghouse according to some implementations. The process 800 may be performed by the SFH 150 of FIGS. 1, 2, 3, 4, 5, and 6.

At 802, transaction data comprising a plurality of retailer transactions may be received from a retailer. At 804, the plurality of transaction may be stored to create a plurality of stored transactions. For example, in FIG. 5, one of the retailers 202 to 204 may provide the transaction data 230 to the SFH 150. The SFH 150 may store the retailer transactions from the transaction data 230 as the stored transactions 502.

At 806, a first set of stored transactions associated with a first clearinghouse may be identified based on a lender identifier (of each stored transaction of the first set of stored transactions). At 808, the first set of stored transactions may be provided to the first clearinghouse. For example, in FIG. 5, the SFH 150 may identify based on the lender identifier (e.g., the SFH lender identifier 256) of each of the stored transactions 502, the first set of stored transactions 504 that are associated with the first set of lenders 218 and therefore the first clearinghouse 214. The SFH 150 may create the first set of CH transactions 508 based on the first set of stored transactions 504 and send the first set of CH transactions 508 to the first clearinghouse 214.

At 810, in response to receiving first transaction results from the first clearinghouse, a status (of each stored transaction) of the first set of stored transaction may be updated. For example, in FIG. 5, the first clearinghouse 214 may initiate the settlement of the first set of CH transactions 508 by initiating the transfer of funds from lender accounts of the first set of lenders 210 to a retailer account of the first retailer 202. The first clearinghouse 214 may provide the first transaction results 512 indicating, for each transaction of the first set of CH transactions 508, a result of initiating the transfer of funds from lender accounts of the first set of lenders 210 to a retailer account of the first retailer 202.

At 812, a second set of stored transactions associated with a second clearinghouse may be identified based on the lender identifier (of each stored transaction of the second set of stored transactions). At 814, the second set of stored transactions may be provided to the second clearinghouse. For example, in FIG. 5, the SFH 150 may identify based on the lender identifier (e.g., the SFH lender identifier 256) of each of the stored transactions 502, the Qth set of stored transactions 506 (in this example, Q=2) that are associated with the Qth set of lenders 220 and therefore the Qth clearinghouse 216. The SFH 150 may create the Qth set of CH transactions 510 based on the Qth set of stored transactions 506 and send the Qth set of CH transactions 510 to the Qth clearinghouse 216.

At 816, in response to receiving second transaction results from the second clearinghouse, a status (of each transaction) of the second set of stored transaction may be updated. For example, in FIG. 5, the Qth clearinghouse 216 may initiate the settlement of the Qth set of CH transactions 510 by initiating the transfer of funds from lender accounts of the Qth set of lenders 212 to a retailer account of the first retailer 202. The Qth clearinghouse 216 may provide the Qth transaction results 514 indicating, for each transaction of the Qth set of CH transactions 510, a result of initiating the transfer of funds from lender accounts of the first Qth of lenders 212 to a retailer account of the first retailer 202.

At 818, a set of the updated transactions that are associated with the retailer may be identified. At 820, a settlement report that includes the status of each updated transaction of the set of updated transactions may be provided to the retailer. For example, in FIG. 5, a set of the updated transactions 502 that are associated with a particular retailer of the retailers 202 to 204 may be identified based on the SFH retailer 258 of each of the stored transactions 502. The SFH 150 may create the settlement report 516 based on the updated transactions 502 that are associated with the particular retailer and provide the settlement report 516 to the particular retailer.

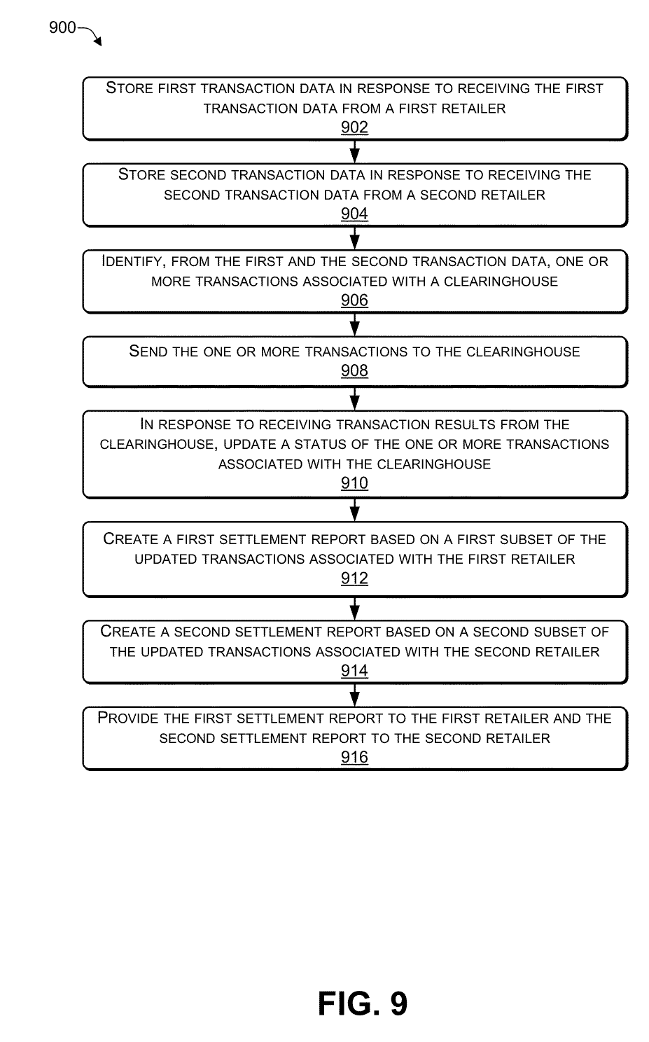

FIG. 9 is a flow diagram of an example process 900 that includes receiving first transaction data from a first retailer and second transaction data from a second retailer according to some implementations. The process 900 may be performed by the SFH 150 of FIGS. 1, 2, 3, 4, 5, and 6.

At 902, first transaction data may be stored in response to receiving the first transaction data from a first retailer. At 904, second transaction data may be stored in response to receiving the second transaction data from a second retailer. For example, in FIG. 6, the SFH 150 may store the first set of stored transactions 606 in response to receiving the first transaction data 602. The SFH 150 may store the Nth set of stored transactions 608 (in this example N=2) in response to receiving the Nth transaction data 604.

At 906, one or more transactions associated with a clearinghouse may be identified from the first and second transaction data. At 908, the one or more transactions may be sent to the clearinghouse. For example, in FIG. 6, the SFH 150 may, based on the lender identifier, identify a portion of the stored transactions 502 (e.g., including the set of stored transactions 606 to 608) that are associated with a particular clearinghouse of the clearinghouses 214 to 216. The SFH 150 may create the CH transactions 610 based on the portion of the stored transactions associated with the particular clearinghouse.

At 910, in response to receiving transaction results from the clearinghouse, a status of the one or more transactions associated with the clearinghouse may be updated. For example, in FIG. 6, the SFH 150 may receive transaction results associated with the particular clearinghouse initiating a transfer of funds from one or more lender accounts to (1) a first retailer account associated with the first retailer 202 and (2) an Nth retailer account associated with the Nth retailer 204. The SFH 150 may update the set of stored transactions 606 and 608 based on the transaction results 612.

At 912, a first settlement report may be created based on a first subset of the updated transactions associated with the first retailer. At 914, a second settlement report may be created based on a second subset of the updated transactions associated with the second retailer. At 916, the first settlement report may be provided to the first retailer and the second settlement report may be provided to the second retailer. The SFH 150 may create the first settlement report 410 based on the first set of stored transactions 606 that are associated with the first retailer 202. The SFH 150 may create the Nth settlement report 412 based on the Nth set of stored transactions 608 that are associated with the Nth retailer 204. The SFH 150 may send the first settlement report 410 to the first retailer 202 and the Nth settlement report 412 to the Nth retailer 204.

### Example Computing Device and Environment

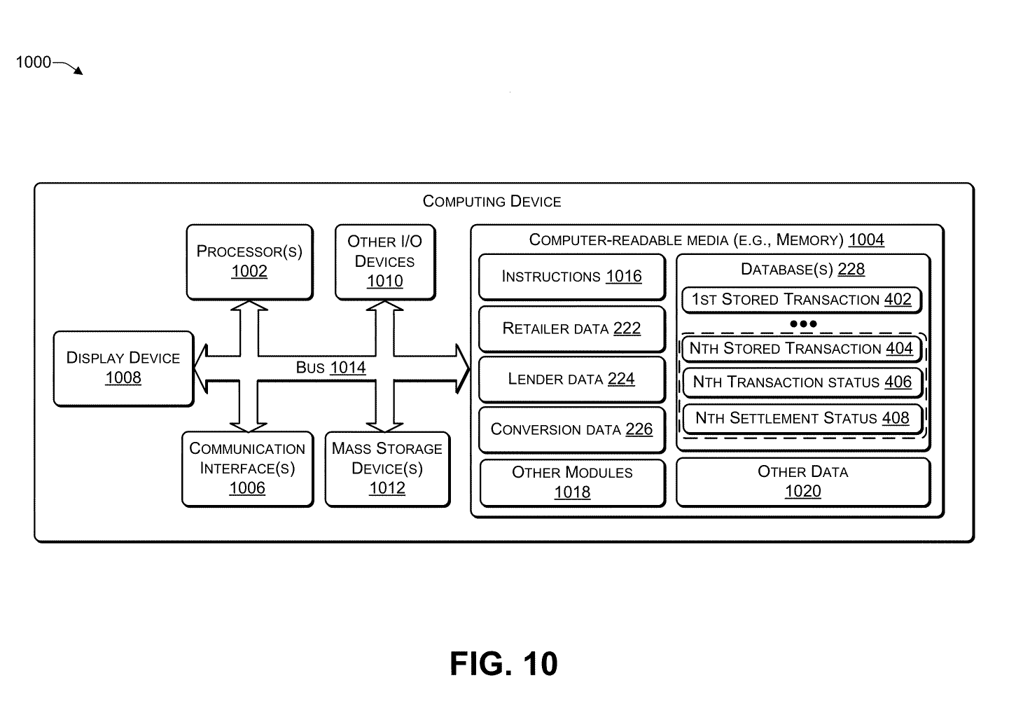

FIG. 10 illustrates an example configuration of a computing device 1000 and environment that can be used to implement the modules and functions described herein. For example, the computing device 102, the server 104, the disclosure system 148, the SFH 150, the credit bureau 106, the agent 146, and the lenders 108 to 110 may each include an architecture that is similar to or based on the computing device 1000.

The computing device 1000 may include one or more processors 1002, a memory 1004, communication interfaces 1006, a display device 1008, other input/output (I/O) devices 1010, and one or more mass storage devices 1012, able to communicate with each other, such as via a system bus 1014 or other suitable connection. The I/O devices 1010 may include a keyboard, a mouse, a touchscreen display, a touch-sensitive pad and stylus, a camera, a scanner, a fax machine, etc.

The processor 1002 may be a single processing unit or a number of processing units, all of which may include single or multiple computing units or multiple cores. The processor 1002 may be implemented as one or more microprocessors, microcomputers, microcontrollers, digital signal processors, central processing units, state machines, logic circuitries, and/or any devices that manipulate signals based on operational instructions. Among other capabilities, the processor 1002 may be configured to fetch and execute computer-readable instructions stored in the memory 1004, mass storage devices 1012, or other computer-readable media.

Memory 1004 and mass storage devices 1012 are examples of computer storage media for storing instructions, which are executed by the processor 1002 to perform the various functions described above. For example, memory 1004 may generally include both volatile memory and non-volatile memory (e.g., RAM, ROM, or the like). Further, mass storage devices 1012 may generally include hard disk drives, solid-state drives, removable media, including external and removable drives, memory cards, flash memory, floppy disks, optical disks (e.g., CD, DVD), a storage array, a network attached storage, a storage area network, or the like. Both memory 1004 and mass storage devices 1012 may be collectively referred to as memory or computer storage media herein, and may be capable of storing computer-readable, processor-executable program instructions as computer program code that can be executed by the processor 1002 as a particular machine configured for carrying out the operations and functions described in the implementations herein.

Computer storage media includes non-transitory media, such as non-volatile, removable and non-removable media implemented in any method or technology for storage of information, such as computer readable instructions, data structures, program modules, or other data. Computer storage media includes RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device.

In contrast, communication media may embody computer readable instructions, data structures, program modules, or other data in a modulated data signal, such as a carrier wave. As defined herein, computer storage media does not include communication media.

The computing device 1000 may also include one or more communication interfaces 1006 for exchanging data with other devices, such as via a network, direct connection, or the like, as discussed above. The communication interfaces 1006 can facilitate communications within a wide variety of networks and protocol types, including wired networks (e.g., LAN, cable, etc.) and wireless networks (e.g., WLAN, cellular, satellite, etc.), the Internet and the like. Communication interfaces 1006 can also provide communication with external storage (not shown), such as in a storage array, network attached storage, storage area network, or the like.

A display device 1008, such as a monitor may be included in some implementations for displaying information and images to users. Other I/O devices 1010 may be devices that receive various inputs from a user and provide various outputs to the user, and may include a keyboard, a remote controller, a mouse, a printer, audio input/output devices, voice input, and so forth.

Memory 1004 may include modules and components to perform the functions of the SFH 150 according to the implementations described herein. The memory 1004 may include instructions 1016 that are executable by the processors 1002 to perform the various functions of the SDH 150 as described herein. The memory 1004 may include the retailer data 222, the lender data 224, the conversion data 226, and the databases 228 that are capable of storing the stored transactions 402 to 404. The memory 1004 may also include other modules 1018 that implement other features and other data 1020 that includes intermediate calculations and the like. The other modules 1018 may include various software, such as an operating system, drivers, communication software, or the like.

Although illustrated in FIG. 10 as being stored in memory 1004 of computing device 1000, the instructions 1016, other modules 1020, and other data 1022, or portions thereof, may be implemented using any form of computer-readable media that is accessible by the computing device 1000. As used herein, “computer-readable media” includes non-transitory media.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

What is claimed is:

1. A method performed by one or more processors executing instructions to perform acts comprising:
retrieving, by a settlement facilitation hub, transaction data comprising data associated with a plurality of retailer transactions;
creating, by the settlement facilitation hub, a plurality of modified transactions corresponding to each of the plurality of retailer transactions;
storing the plurality of modified transactions to create a plurality of stored transactions, each of the plurality of stored transactions comprising a transaction amount, a transaction identifier, a retailer identifier, and a lender identifier; and
associating a status with each of the plurality of stored transactions.

2. The method as recited in claim 1, the acts further comprising:
for each stored transaction of the plurality of stored transactions, determining a clearinghouse associated with a lender that is identified by the lender identifier of each stored transaction;
identifying one or more stored transactions of the plurality of stored transactions as being associated with a particular clearinghouse;
creating one or more clearinghouse transactions based at least partly on the one or more stored transactions that are associated with the particular clearinghouse, each of the one or more clearinghouse transactions including the transaction amount, the transaction identifier, the retailer identifier, and the lender identifier; and
providing the one or more clearinghouse transactions to the particular clearinghouse.

3. The method as recited in claim 2, wherein, for each of the one or more clearinghouse transactions, the particular clearinghouse performs acts comprising:
determining the lender that is identified by the lender identifier;
determining a retailer that is identified by the retailer identifier; and
initiating a transfer of funds from a lender account associated with the lender to a retailer account associated with the retailer.

4. The method as recited in claim 3, wherein the particular clearinghouse performs acts comprising:
for each of the one or more clearinghouse transactions, determining a result of the transfer of funds from the lender account associated with the lender to the retailer account associated with the retailer; and
providing, from the particular clearinghouse to the settlement facilitation hub, transaction results that include the result of the transfer of funds for each of the one or more clearinghouse transactions.

5. The method as recited in claim 4, the acts further comprising:
receiving, by the settlement facilitation hub, the transaction results, the transaction results including the result of the transfer of funds for each of the one or more clearinghouse transactions; and
updating, based on the transaction results, the status of the stored transactions that correspond to the one or more clearinghouse transactions to create one or more updated transactions.

6. The method as recited in claim 5, the acts further comprising:
identifying, based on the retailer identifier, a subset of the updated transactions that are associated with the retailer;
creating a settlement report that comprises the status of each updated transaction of the subset of the updated transactions; and
providing the settlement report to the retailer.

7. The method as recited in claim 6, wherein, when the status of a particular updated transaction indicates a successful settlement, the settlement report further comprises an amount of the funds transferred.

8. A settlement facilitation hub comprising:
one or more processors;
one or more non-transitory computer-readable storage media storing instructions executable by the one or more processors to perform acts comprising:
retrieving, from a retailer, transaction data comprising a plurality of retailer transactions;
storing the plurality of retailer transactions in the one or more computer-readable storage media to create a plurality of stored transactions, each of the plurality of stored transactions comprising a transaction amount, a transaction identifier, a retailer identifier, and a lender identifier; and
associating a status with each of the plurality of stored retailer transactions.

9. The settlement facilitation hub as recited in claim 8, the acts further comprising:
identifying a first set of stored transactions of the plurality of stored transactions as being associated with a first clearinghouse based on the lender identifier of each of the first set of stored transactions;
creating a first set of clearinghouse transactions that are associated with the first clearinghouse based on the first set of stored transactions; and
providing the first set of clearinghouse transactions to the first clearinghouse.

10. The settlement facilitation hub as recited in claim 9, the acts further comprising:
receiving, from the clearinghouse, first transaction results that include a result of initiating a transfer of funds from a first set of lender accounts to an account associated with the retailer for each of the first set of clearinghouse transactions; and
updating, based on the first transaction results, the status of the first set of stored transactions that correspond to the first set of clearinghouse transactions to create first updated transactions.

11. The settlement facilitation hub as recited in claim 10, the acts further comprising:
identifying a second set of stored transactions of the plurality of stored transactions as being associated with a second clearinghouse based on the lender identifier;
creating a second set of clearinghouse transactions that are associated with the second clearinghouse based on the one or more stored transactions; and
providing the second set of clearinghouse transactions to the second clearinghouse.

12. The settlement facilitation hub as recited in claim 11, the acts further comprising:
receiving, from the second clearinghouse, second transaction results that include a result of initiating a transfer of funds from a second set of lender accounts to an account associated with the retailer for each of the second set of clearinghouse transactions; and
updating, based on the second transaction results, the status of second set of stored transactions that correspond to the second set of clearinghouse transactions to create second updated transactions.

13. The settlement facilitation hub as recited in claim 12, the acts further comprising:
identifying, based on the retailer identifier, a subset of the first and second set of updated transactions that are associated with the retailer;
creating a settlement report that comprises the status of each updated transaction of the subset; and
providing the settlement report to the retailer.

14. One or more non-transitory computer-readable storage media including instructions that are executable by one or more processors to perform acts comprising:
receiving, from a first retailer, first transaction data associated with a first plurality of retailer transactions;
storing the first plurality of retailer transactions to create a first plurality of stored transactions, each of the first plurality of stored transactions comprising a transaction amount, a transaction identifier, a retailer identifier, and a lender identifier; and
associating a status with each of the first plurality of stored transactions.

15. The one of more non-transitory computer-readable storage media as recited in claim 14, the acts further comprising:
receiving, from a second retailer, second transaction data associated with a second plurality of retailer transactions;
storing the second plurality of retailer transactions to create a second plurality of stored transactions, each of the second plurality of stored transactions comprising the transaction amount, the transaction identifier, the retailer identifier, and the lender identifier; and
associating the status with each of the second plurality of stored transactions.

16. The one of more non-transitory computer-readable storage media as recited in claim 15, the acts further comprising:
identifying one or more stored transactions of the first and second plurality of stored transactions as being associated with a clearinghouse based on the lender identifier;
creating a set of clearinghouse transactions that are associated with the clearinghouse based on the one or more stored transactions; and
providing the set of clearinghouse transactions to the clearinghouse.

17. The one of more non-transitory computer-readable storage media as recited in claim 16, the acts further comprising:
receiving, from the clearinghouse, transaction results that include a result of initiating a transfer of funds for each of the set of clearinghouse transactions; and
updating, based on the transaction results, the status of at least a portion of the stored transactions that correspond to the set of clearinghouse transactions to create updated transactions.

18. The one of more non-transitory computer-readable storage media as recited in claim 17, the acts further comprising:
identifying, based on the retailer identifier, a first subset of the updated transactions that are associated with the first retailer;
creating a first settlement report that comprises the status of each of the first subset of the updated transactions; and
providing the first settlement report to the first retailer.

19. The one of more non-transitory computer-readable storage media as recited in claim 18, the acts further comprising:
identifying, based on the retailer identifier, a second subset of the updated transactions that are associated with the second retailer;
creating a second settlement report that comprises the status of each of the second subset of the updated transactions; and
providing the second settlement report to the second retailer.

20. The one of more non-transitory computer-readable storage media as recited in claim 14, wherein the status comprises one of cleared, processing, settled, or exception.
